(19) United States
(12) Patent Application Publication
(10) Pub. No.: US 2005/0086706 A1
(43) Pub. Date: Apr. 21, 2005

(54) Television system

(76) Inventors: Hideki Kasamatsu, Katano City Osaka (JP); Yoshikazu Mihara, Kawanishi City Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/504,823

(22) PCT Filed: Feb. 19, 2003
(86) PCT No.: PCT/JP03/01832

(30) Foreign Application Priority Data
Feb. 21, 2002 (JP) 2002-44988

(51) Int. Cl. H04N 7/173; H04N 5/50; H04N 7/16; H04N 7/18

(52) U.S. Cl. 725/139; 725/131; 725/80; 348/731; 725/100

(57) ABSTRACT

A main television set comprises a plurality of tuners, a selection circuit for selecting, out of receiving signals received by the plurality of tuners, the receiving signal for broadcasting on the main television set as well as selecting the receiving signal for broadcasting on the sub-television set, a first signal processing circuit for processing the receiving signal for broadcasting on the main television set selected by the selection circuit, to generate a video signal and an audio signal for broadcasting on the main television set, a first wireless transmission unit for wireless-transmitting to the sub-television set the receiving signal for broadcasting on the sub-television set selected by the selection circuit, and first control means for controlling the plurality of tuners, the selection circuit, and the first wireless transmission unit.

### TECHNICAL FIELD

The present invention relates to a television system in which a program received by a main television set can be viewed by a sub-television set.

### BACKGROUND ART

BY diversification of broadcasting services such as analog terrestrial waves (also digital terrestrial waves in the future), analog BS/CS (Broadcasting Satellite/Communication Satellite), and digital BS/CS, television receivers (TVs) each containing a plurality of tuners have increased in number.

When a user desires to simultaneously view a plurality of programs by one TV set, a plurality of programs may be simultaneously displayed on the one TV set by picture-in-picture. When the plurality of programs are simultaneously displayed by picture-in-picture, however, a video on a sub-screen generally decreases in size, and a video on a main screen is a video whose part is chipped by the sub-screen. Therefore, the videos on the respective screens are difficult to see. Further, an audio, corresponding to either one of the screens, can be only outputted.

As another method, a program received by an installed TV set (a main TV set) can be also broadcast on another TV set by connecting the other TV set to the main TV set via an AV cable. In this case, however, the other TV set must be connected to the main TV set. Accordingly, the other TV set cannot be installed at a position spaced farther apart from the main TV set. Further, the other TV set contains a tuner, which is useless.

The TV set (main TV set) is generally installed near an indoor antenna terminal. When it is desired to view a television program in the place where there exists no indoor antenna terminal, for example, a kitchen, a restroom, or a bathroom, it is considered that an antenna cable is newly interconnected in the place and is connected to another TV set installed in the place, another TV set is put in the place and an indoor antenna is connected thereto, or another TV set comprising an indoor antenna is prepared.

In a method of newly interconnecting an antenna cable, however, it takes time and labor to interconnect the antenna cable, and the appearance is marred. Although a method of connecting an indoor antenna to another TV set or preparing another TV set comprising an indoor antenna may be realized in terrestrial wave broadcasting, it is not realistic in BS/CS broadcasting because the antenna must be put outside and always directed toward satellites.

An object of the present invention is to provide a television system in which a program received by a main television set can be received by a sub-television set without connecting the sub-television set to the main television set via an AV cable and that eliminates the necessity of interconnecting an antenna cable or providing an indoor antenna for the sub-television set.

### DISCLOSURE OF INVENTION

The present invention is directed to a television system comprising a main television set and a sub-television set, characterized in that the main television set comprises a plurality of tuners, a selection circuit for selecting, out of receiving signals received by the plurality of tuners, the receiving signal for broadcasting on the main television set as well as selecting the receiving signal for broadcasting on the sub-television set, a first signal processing circuit for processing the receiving signal for broadcasting on the main television set selected by the selection circuit, to generate a video signal and an audio signal for broadcasting on the main television set, a first wireless transmission unit for wireless-transmitting to the sub-television set the receiving signal for broadcasting on the sub-television set selected by the selection circuit, and first control means for controlling the plurality of tuners, the selection circuit, and the first wireless transmission unit, and the sub-television set comprises a second wireless transmission unit for receiving the receiving signal for broadcasting on the sub-television set transmitted from the first wireless transmission unit in the main television set, a second signal processing circuit for processing the receiving signal for broadcasting on the sub-television set received by the second wireless transmission unit, to generate a video signal and an audio signal for broadcasting on the sub-television set, and a second control unit for controlling the second wireless transmission unit.

It is preferable that the first wireless transmission unit and the second wireless transmission unit can bidirectionally communicate various types of commands to each other.

It is preferable that each of the tuners is a digital tuner for receiving digital broadcasting, a digital AV stream outputted from each of the digital tuners is inputted to the selection circuit, and the first signal processing circuit comprises a decoder for decoding the receiving signal for broadcasting on the main television set selected by the selection circuit.

It is preferable that the plurality of tuners comprise digital tuners for receiving digital broadcasting and analog tuners for receiving analog broadcasting, a digital AV stream outputted from each of the digital tuners is inputted to the selection circuit, an analog video signal and an analog audio signal which are outputted from the analog tuner are encoded after being respectively converted into digital signals, and are further multiplexed to be converted into an AV stream, which is then inputted to the selection circuit, and the first signal processing circuit comprises a decoder for decoding the receiving signal for broadcasting on the main television set selected by the selection circuit.

It is preferable that there is provided a switch for selecting either the video signal and the audio signal which are generated by the first signal processing circuit or the video signal and the audio signal which are outputted from the analog tuner and have not been encoded and outputting the selected video signal and audio signal, the switch is so controlled that when the receiving signal for broadcasting on the main television set selected by the selection circuit is the AV stream generated on the basis of the output of the analog tuner, the video signal and the audio signal which are outputted from the analog tuner and have not been encoded are selected, and the switch is so controlled that when the receiving signal for broadcasting on the main television set selected by the selection circuit is an AV stream outputted from the digital tuner, the video signal and the audio signal which are generated by the first signal processing circuit are selected

### BRIEF DESCRIPTION OF DRAWINGS

FIG. 1 is a block diagram showing the configuration of a main TV set.

FIG. 2 is a block diagram showing the configuration of a sub-TV set.

FIG. 3 is a block diagram showing another example of the configuration of a main TV set.

FIG. 4 is a block diagram showing still another example of the configuration of a main TV set.

### BEST MODE FOR CARRYING OUT THE INVENTION

Referring now to the drawings, an embodiment of the present invention will be described.

A television system comprises a main television (main TV) set and a sub-television (sub-TV) set.

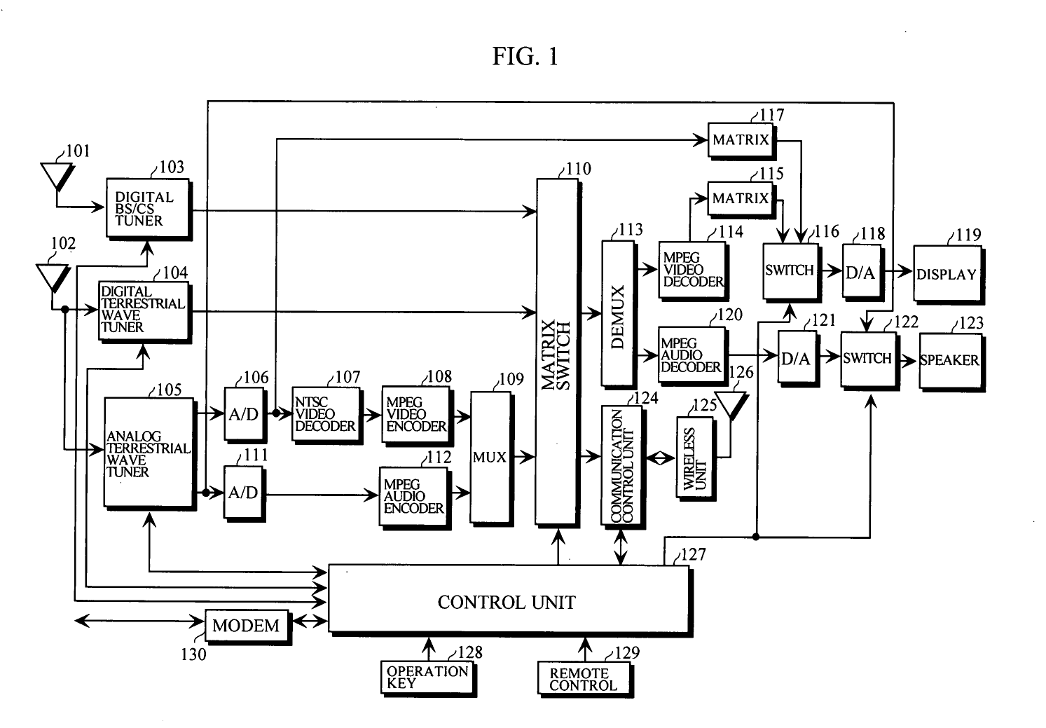

FIG. 1 illustrates the configuration of the main TV set.

The main TV set comprises three types of tuners, i.e., a digital BS/CS tuner 103, a digital terrestrial wave tuner 104, and an analog terrestrial wave tuner 105.

A BS/CS receiving antenna 101 is connected to the digital BS/CS tuner 103. A terrestrial wave receiving antenna 102 is connected to the digital terrestrial wave tuner 104 and the analog terrestrial wave tuner 105.

A digital BS/CS broadcasting signal received by the antenna 101 is fed to the digital BS/CS tuner 103. A TS (Transport Stream) signal outputted from the digital BS/CS tuner 103 is inputted to a matrix switch 110.

A digital terrestrial wave broadcasting signal received by the antenna 102 is distributed between the digital terrestrial wave tuner 104 and the analog terrestrial wave tuner 105. A digital AV stream signal outputted from the digital terrestrial wave tuner 104 is inputted to the matrix switch 110.

An NTSC (National Television System Standard Committee) video signal outputted from the analog terrestrial wave tuner 105 is digitized by an A/D (Analog-to-Digital) converter 106, and is then inputted to an NTSC video decoder 107. The NTSC video decoder 107 decodes an NTSC video signal, to generate a digital luminance signal Y and digital chrominance signals Cb and Cr. The luminance signal Y and the chrominance signals Cb and Cr outputted from the NTSC video decoder 107 are inputted to an MPEG (Motion Picture Expert Group) video encoder 108, and are subjected to bandwidth compression (encoding) processing.

On the other hand, an audio signal outputted from the analog terrestrial wave tuner 105 is digitized by an A/D converter 111. The audio signal outputted from the A/D converter 111 is inputted to an MPEG audio encoder 112, and is subjected to bandwidth compression (encoding) processing.

The video signal encoded by the NTSC video encoder 108 and the audio signal encoded by the MPEG audio encoder 112 are multiplexed by an MUX (Multiplexer) circuit 109, to be converted into a TS signal, and the TS signal is inputted to the matrix switch 110.

The matrix switch 110 selects, out of TS signals in three systems inputted thereto, the TS signal in the one system including a program to be broadcast on the main TV set, to feed the selected TS signal to a DEMUX (Demultiplexer) circuit 113, and selects the TS signal in the one system including a program to be broadcast on the sub-TV set, to feed the selected TS signal to a communication control unit 124. The matrix switch 110 is controlled by a control unit 127.

The DEMUX 113 separates the TS signal fed from the matrix switch 110 into a video signal and an audio signal. The video signal obtained by the DEMUX 113 is fed to an MPEG video decoder 114. The MPEG video decoder 114 decodes the video signal, to generate a luminance signal Y and chrominance signals Cb and Cr. The luminance signal Y and the chrominance signals Cb and Cr which are generated by the MPEG video decoder 114 are converted into an RGB signal by a matrix circuit 115, and the RGB signal is then inputted to a switch 116.

The digital NTSC signal outputted from the A/D converter 106 is also fed to a matrix circuit 117. The matrix circuit 117 converts the NTSC signal into an RGB signal. The RGB signal obtained by the matrix circuit 117 is inputted to the switch 116. The switch 116 selects one of the RGB signals respectively inputted from both the matrix circuits 115 and 117 as an analog-video signal, and outputs the analog video signal. The analog video signal outputted from the switch 116 is fed to a display 119 in the main TV set and displayed thereon.

The audio signal obtained by the DEMUX 113 is decoded by an MPEG audio decoder 120, and the decoded audio signal is then fed to a D/A (Digital-to-Analog) converter 121 and converted into an analog signal. The audio signal outputted from the D/A converter 121 is inputted to a switch 122. The audio signal outputted from the analog terrestrial wave tuner 105 is also inputted to the switch 122. The switch 122 selects one of the audio signals respectively inputted from the D/A converter 121 and the analog terrestrial wave tuner 105, and outputs the selected audio signal. The audio signal outputted from the switch 122 is fed to a speaker 123 and outputted.

The switches 116 and 122 are controlled by the control unit 127. That is, the switches 116 and 122 are so controlled that when the main TV set broadcasts the program received by the analog terrestrial wave tuner 105, the switch 116 selects the video signal outputted from the matrix circuit 117, and the switch 122 selects the audio signal outputted from the analog terrestrial wave tuner 105. Further, the switches 116 and 122 are so controlled that when the main TV set broadcasts the programs received by the other tuners 103 and 104, the switch 116 selects the video signal outputted from the matrix circuit 115, and the switch 122 selects the audio signal outputted from the D/A converter 121.

The switches 116 and 122 are thus controlled, thereby preventing the image quality and the sound quality from being degraded by respectively encoding and decoding an analog terrestrial wave broadcasting signal.

The communication control unit 124 transmits the TS signal fed from the matrix switch 110 to the sub-TV set through a wireless unit 125 and an antenna 126. The communication control unit 124, the wireless unit 125, and the antenna 126 constitute a wireless communication unit for establishing bidirectional communication with the sub-TV set.

The control unit 127 selects the tuner for receiving a corresponding broadcasting signal and controls each of the units in the main TV set by a channel selection command from an operation key 128 or a remote control 129 besides controlling the matrix switch 110 and the switches 116 and 122. The control unit 127 brings the tuner which is not employed into a standby state for power saving.

The control unit 127 exchanges a command with the communication control unit 124, to control the wireless communication unit. As described later, a control signal such as a channel selection control signal for the sub-TV set is fed to the control unit 127 through the wireless communication unit from the sub-TV set.

The control unit 127 is connected to a telephone line through a modem 130 in order to notify a management company of a digital broadcasting viewing history or the like.

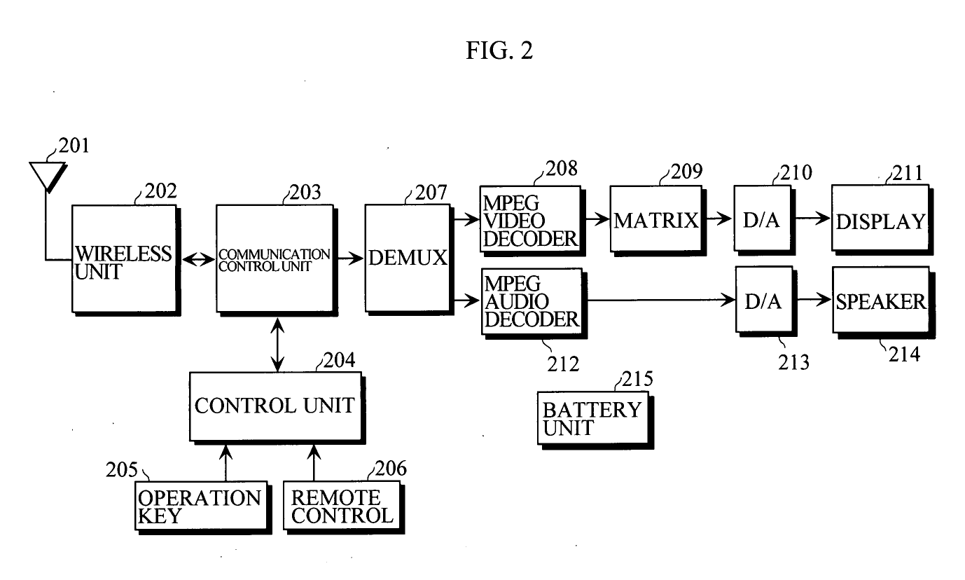

FIG. 2 illustrates the configuration of the sub-TV set.

The sub-TV set comprises a wireless communication unit which communicates with the main TV set. The wireless communication unit comprises an antenna 201, a wireless unit 202, and a communication control unit 203. The communication control unit 203 establishes communication with a control unit 204, to bidirectionally communicate a command based on an instruction from an operation key 205 or a remote control 206.

When a TS signal from the main TV set is received by the wireless communication unit, the received TS signal is fed to a DEMUX 207, and is separated into a video signal and an audio signal. The video signal obtained by the DEMUX 207 is fed to an MPEG video decoder 208. The MPEG video decoder 208 decodes the video signal, to generate a luminance signal Y and chrominance signals Cb and Cr. The luminance signal Y and the chrominance signals Cb and Cr which are generated by the MPEG video decoder 208 are converted into an RGB signal by a matrix circuit 209, and the RGB signal is then fed to a display 211 through a D/A converter 210.

The audio signal obtained by the DEMUX 207 is decoded by an MPEG audio decoder 212, and the decoded audio signal is then fed to a speaker 14 through a D/A converter 213 and outputted.

In this example, the power to the sub-TV set is supplied by a battery unit 215 in order to also eliminate the necessity of a power cable for the sub-TV set to enhance movability. The power may be supplied by an AC (Alternating Current) adaptor or the like.

In the above-mentioned television system, a program received by the main TV set is sent to the sub-TV set by wireless so that it can be broadcast on the sub-TV set. Therefore, it is possible to freely move the sub-TV set within a range in which communication can be established, and it is possible to make effective use, out of the tuners provided in the main TV set, of the tuner which is not employed for broadcasting on the main TV set.

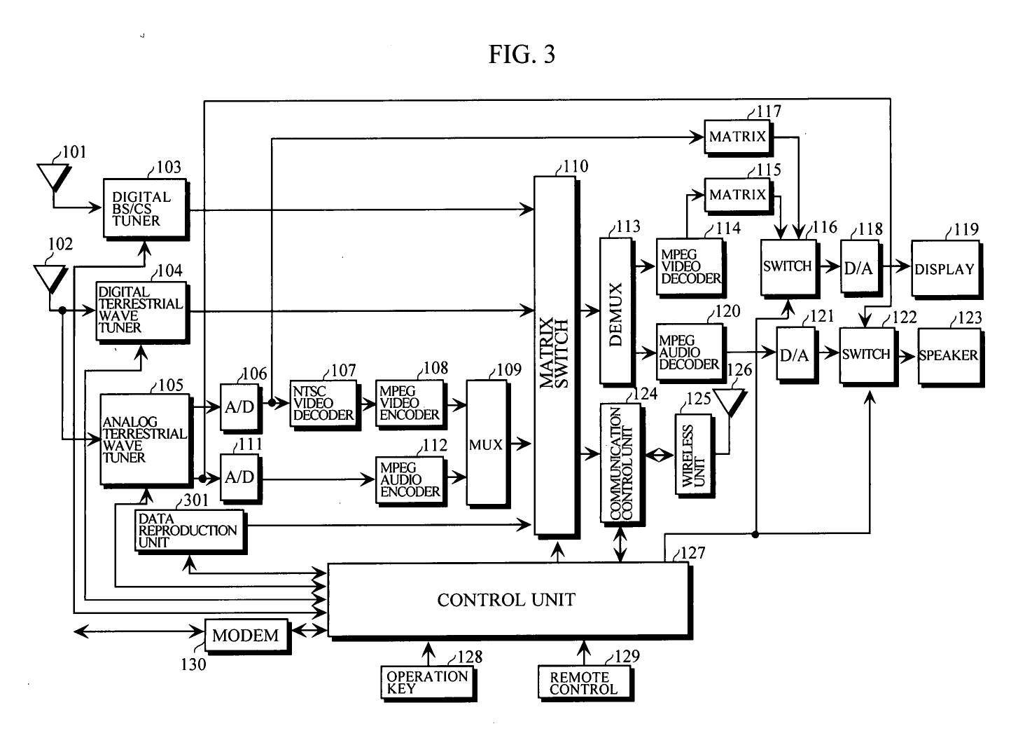

As shown in FIG. 3, a data reproduction unit 301 for reproducing AV data recorded on a recording medium such as a DVD (Digital Video Disc) may be added to the main TV set, and an AV stream signal reproduced by the data reproduction unit 301 (an encoded video and/or audio AV stream signal) may be inputted to the matrix switch 110.

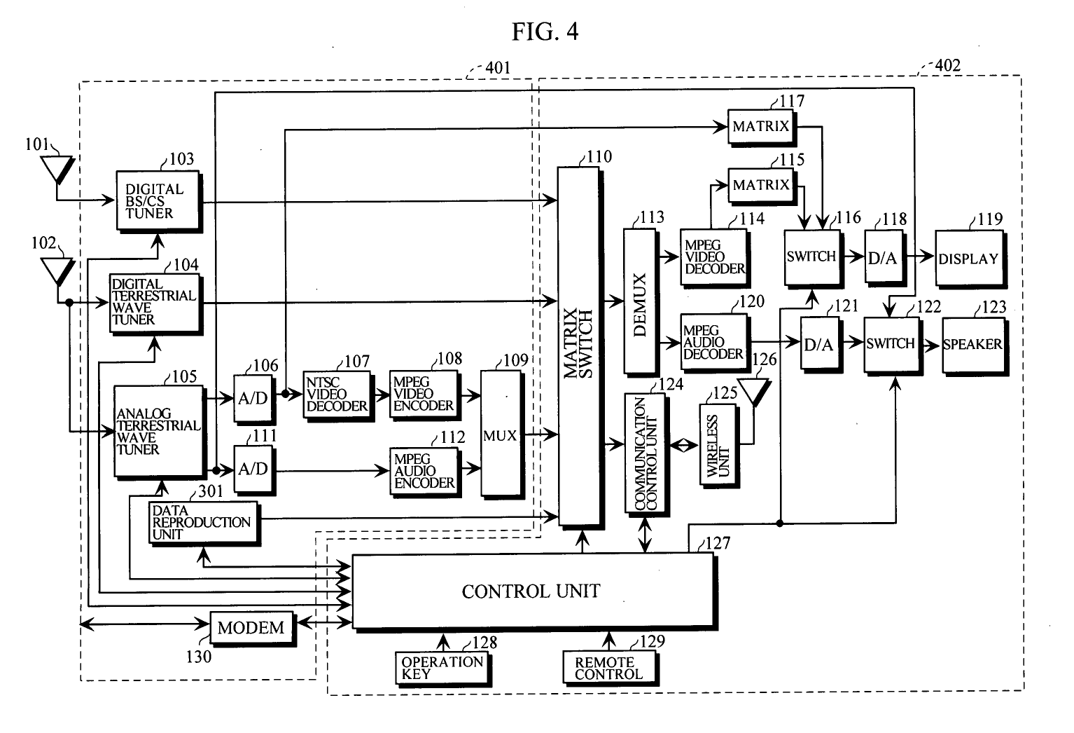

As shown in FIG. 4, a tuner 401 comprising the plurality of tuners 103, 104, and 105 and the data reproduction unit 301 in the main TV set shown in FIG. 3 and a display unit 402 comprising the matrix switch 110, the control unit 127, the wireless communication units 124, 125, and 126, the display 119, the speaker 123, and so on in the main TV set may be respectively configured as separate units.

Furthermore, a plurality of sub-TV sets may be provided with respect to the main TV set. As a transmission system in a wireless communication unit between the main TV set and the sub-TV set, a radio wave system can be employed. In this case, a 2.4 GHz band and a 5 GHz band in which frequencies are opened throughout the world, for example, can be utilized. Further, as a transmission system in a wireless communication unit between the main TV set and the sub-TV set, an infrared transmission system may be utilized.

Although in the above-mentioned embodiment, description was made of a case where MPEG is used as a compression system of a video/audio signal, it goes without saying that the present invention is also applicable to a case where the other compression system is employed.

1. A television system comprising a main television set and a sub-television set, characterized in that
the main television set comprises a plurality of tuners; a selection circuit for selecting, out of receiving signals received by the plurality of tuners, the receiving signal for broadcasting on the main television set as well as selecting the receiving signal for broadcasting on the sub-television set; a first signal processing circuit for processing the receiving signal for broadcasting on the main television set selected by the selection circuit, to generate a video signal and an audio signal for broadcasting on the main television set; a first wireless transmission unit for wireless-transmitting to the sub-television set the receiving signal for broadcasting on the sub-television set selected by the selection circuit; and first control means for controlling the plurality of tuners, the selection circuit, and the first wireless transmission unit, and
the sub-television set comprises a second wireless transmission unit for receiving the receiving signal for broadcasting on the sub-television set transmitted from the first wireless transmission unit in the main television set; a second signal processing circuit for processing the receiving signal for broadcasting on the sub-television set received by the second wireless transmission unit, to generate a video signal and an audio signal for broadcasting on the sub-television set; and a second control unit for controlling the second wireless transmission unit.

2. The television system according to claim 1, characterized in that
the first wireless transmission unit and the second wireless transmission unit can bidirectionally communicate various types of commands to each other.

3. The television system according to claim 1, characterized in that
each of the tuners is a digital tuner for receiving digital broadcasting, a digital AV stream outputted from each of the digital tuners is inputted to the selection circuit, and the first signal processing circuit comprises a decoder for decoding the receiving signal for broadcasting on the main television set selected by the selection circuit.

4. The television system according to claim 1, characterized in that
the plurality of tuners comprise digital tuners for receiving digital broadcasting and analog tuners for receiving analog broadcasting,
a digital AV stream outputted from each of the digital tuners is inputted to the selection circuit,
an analog video signal and an analog audio signal which are outputted from the analog tuner are encoded after being respectively converted into digital signals, and are further multiplexed to be converted into an AV stream, which is then inputted to the selection circuit, and
the first signal processing circuit comprises a decoder for decoding the receiving signal for broadcasting on the main television set selected by the selection circuit.

5. The television system according to claim 4, characterized in that
there is provided a switch for selecting either the video signal and the audio signal which are generated by the first signal processing circuit or the video signal and the audio signal which are outputted from the analog tuner and have not been encoded and outputting the selected video signal and audio signal,
the switch is so controlled that when the receiving signal for broadcasting on the main television set selected by the selection circuit is the AV stream generated on the basis of the output of the analog tuner, the video signal and the audio signal which are outputted from the analog tuner and have not been encoded are selected, and
the switch is so controlled that when the receiving signal for broadcasting on the main television set selected by the selection circuit is an AV stream outputted from the digital tuner, the video signal and the audio signal which are generated by the first signal processing circuit are selected.
